(19) United States
(12) Patent Application Publication
(10) Pub. No.: US 2015/0382082 A1
(43) Pub. Date: Dec. 31, 2015

(54) SYSTEM AND METHOD FOR INTERACTIVE TELEVISION PROGRAM

(71) Applicant: Don Buckner, Okahumpka, FL (US)

(72) Inventor: Don Buckner, Okahumpka, FL (US)

(21) Appl. No.: 14/316,297

(22) Filed: Jun. 26, 2014

(51) Int. Cl. H04N 21/8545; H04N 21/239; H04N 21/258; G06Q 40/06; H04N 21/488; H04N 21/61; H04N 21/4782; H04N 7/173; H04N 21/478

(52) U.S. Cl. CPC H04N 21/8545; H04N 7/17318; H04N 21/239; H04N 21/25866; H04N 21/478; H04N 21/488; H04N 21/6125; H04N 21/4782; G06Q 40/06

(57) ABSTRACT

A system and method for an interactive television program is disclosed. In a particular embodiment, the method includes broadcasting a presentation of a selected entrepreneur, where the presentation is to persuade viewers to invest in a particular product or service. In addition the method includes receiving a pledge from a viewer to invest in the particular product or service through an Internet, social media, mobile devices, or any combination thereof, and broadcasting results of the pledges for the particular product or service. The method also includes collecting the pledges, transmitting an investor agreement to each viewer that made a pledge when the selected entrepreneur accepts the pledge, and disbursing the pledges to the selected entrepreneur upon receiving the investor agreement executed by the viewer.

### FIELD

The present invention relates in general to a system and method for an interactive television program.

### DESCRIPTION OF RELATED ART

Reality television programs provide an opportunity for amateur contestants to perform on a national stage. Often times the show rules allow the viewers watching the television program to vote for a particular contestant, which permits that contestant to continue participating in the show. For example, viewers may use text messaging to participate and vote for a contestant during a designated time period. Subsequently during the next airing of the program, the voting results are revealed to the contestants and the audience. A shortcoming of the existing reality talent shows is that there is no instant and real time feedback provided by the viewers. Accordingly, what is needed in the art is a reality talent show that allows contestants to receive real-time feedback while they are performing and the ability to alter their performance in real-time to improve their results.

Another shortcoming of existing reality talent shows is that the contestants must travel to the production studio or other designated location to perform. Thus, a number of potential contestants may be missed due the inability to travel and audition for the show. Accordingly, what is needed in the art is an interactive television program that is mobile and travels to various locations searching for potential contestants.

Yet another shortcoming is the allocation of prizes to the contestants. Typically, the production company awards money prizes to the “winning” contestants in accordance with the rules of the particular talent show. However, what is needed in the art is an interactive television program that allows the viewers to donate money to a particular contestant based on charitable grounds and is not necessarily dependent on the rules of the game for a contestant to receive financial support.

### SUMMARY

A system and method for an interactive television is disclosed. In a particular embodiment, the method includes broadcasting a presentation of a selected entrepreneur, where the presentation is to persuade viewers to invest in a particular product or service. In addition the method includes receiving a pledge from a viewer to invest in the particular product or service through an Internet, social media, mobile devices, or any combination thereof, and broadcasting results of the pledges for the particular product or service. The method also includes collecting the pledges, transmitting an investor agreement to each viewer that made a pledge when the selected entrepreneur accepts the pledge, and disbursing the pledges to the selected entrepreneur upon receiving the investor agreement executed by the viewer.

In another particular embodiment, the method includes identifying a pool of contestants and transmitting a performance of a selected contestant to a television broadcast station. The method also includes broadcasting the performance of the selected contestant to viewers for the viewers to selectively pledge an amount of money for the selected contestant. In addition, the method includes receiving results of pledges made for the selected contestant through an Internet, social media, mobile devices, or any combination thereof, broadcasting the results of the pledges for the selected contestant, collecting the money for the pledges, and disbursing the money to the selected contestant.

In another particular illustrative embodiment, the method includes viewing a presentation of a selected entrepreneur on a viewer device, where the presentation is to persuade viewers to invest in a particular product or service. The method also includes transmitting a pledge from the viewer device to a server operable to interact with the viewer device, viewing results of the pledges for the particular product or service on the viewer device, and receiving an investor agreement when the selected entrepreneur accepts the pledge. In addition, the method includes funding the pledge to the selected entrepreneur upon executing the investor agreement.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a particular illustrative embodiment of a system for a reality real-time talent show, wherein a producer selects a pool of contestants at a remote location;

FIG. 2 is a particular illustrative embodiment of the system for the reality show, wherein a mobile television studio is used to transmit the performance to the broadcast station;

FIG. 3 is a schematic of a particular illustrative embodiment of the performance and real-time results viewed on a television (or mobile device) by the public;

FIG. 4 is a flow diagram of a particular illustrative embodiment of a method for a reality real-time talent show;

FIG. 5 is a flow diagram of a particular illustrative embodiment of a method for a reality real-time talent show; and

FIG. 6 is a block diagram of a particular illustrative embodiment of the system for broadcasting the real-time talent show to the public.

### DETAILED DESCRIPTION

The system and method for an interactive television program is intended to be the most real of all reality shows. The television show may be shot remotely such as at inner city locations and a mobile television studio may be used to travel to seek out contestants who may live on the street but have a song to sing, for example. The contestants may sing an original song or a song that they have heard and sing their version of it. In addition to singing a song, the contestants may tell their personal story, which may elicit sympathy from the public to help out a particular contestant. Accordingly, the reality show accepts donations on behalf of the contestant that will be disbursed to the contestant. The public may also vote for the contestants using a mobile device, social media or the Internet, for example, which will be displayed in real-time to the contestant and the public as the contestant is performing.

Further, corporate sponsors or wealthy personal donors may unite together to support the contestants and be identified, or may also remain anonymous. This is an opportunity to place a face on the homeless and poverty. The reality show may include celebrity guest hosts as well or, other hosts that may have struggled from the streets to become successful. How the donations or exposure has helped the contestants is also broadcast as a follow-up to the real-time performances of the contestants to help promote even more giving in the following episodes. The show provides an avenue to directly help those that are in need.

In another embodiment, the television program may be used to broadcast a presentation by an entrepreneur. The presentation may be a pitch to persuade viewers to invest in a particular product or service. The viewers may pledge a certain amount of money towards the promotion of the product or services, and in return the viewers may receive a percentage of any profits that may be generated in the future. The pledges may be received through the Internet, social media, mobile devices, or any combination thereof.

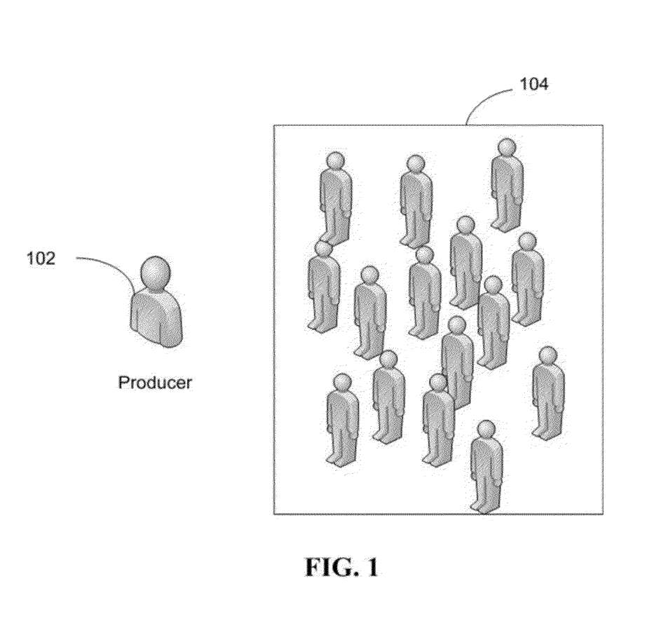

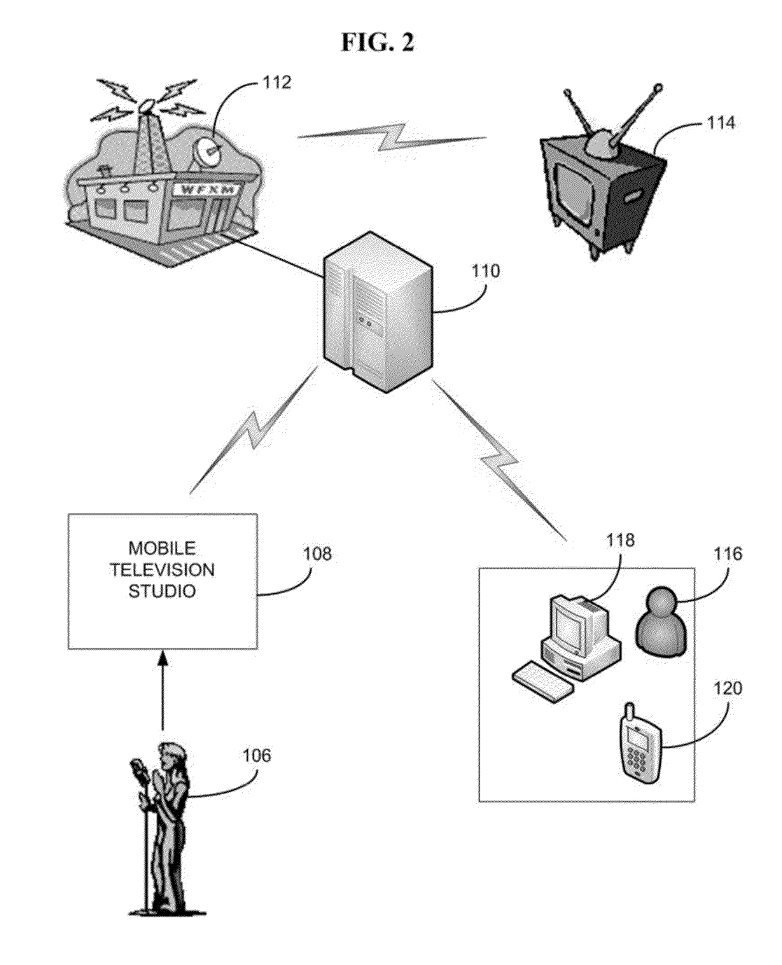

Referring now to FIGS. 1 and 2, the show begins by a producer 102 identifying a pool of participants 104 such as contestants or entrepreneurs. The producer 102 may travel to a remote location to the participants 104. Once the participants are selected, each selected participant 106 is provided an opportunity to discuss their personal background before beginning their performance or presentation.

In one particular illustrative embodiment, a mobile television studio 108 transmits the performance in real-time back to a production server 110 that is in communication with the broadcast station 112. The broadcast station 112 then broadcasts the performance to the public, where it may be viewed on a television 114 or a mobile device, for example. While the performance is being broadcast in real-time, a user 116 may vote and/or make a donation to the contestant 106 using a computer 118 in communication with the Internet or a mobile device 120 to transmit to the production server.

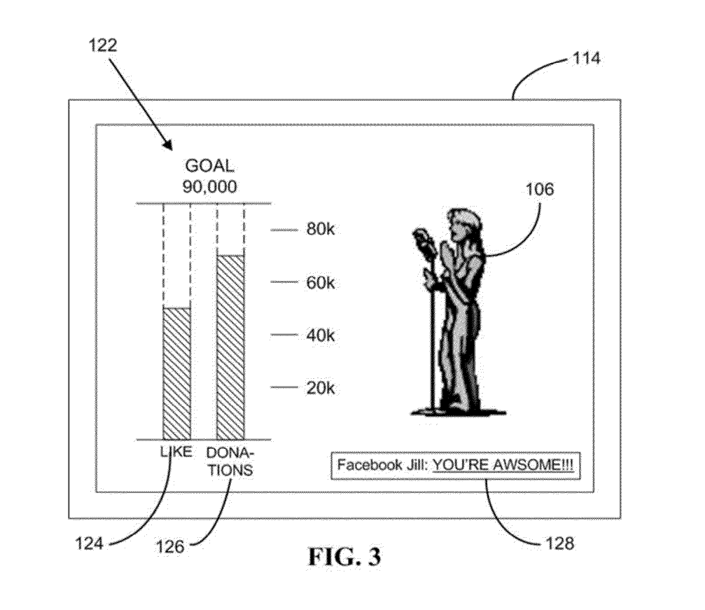

An example of the real-time broadcast displayed on a television 114 is shown in FIG. 3. The contestant 106 is shown performing in real-time with voting results 124 and donations 126 also displayed. In this particular embodiment, the real-time results 122 of the voting 124 and donations 126 are illustrated as a bar chart, where the height of the bar reflects the respective totals. In addition, messages 128 from the public may also be displayed as part of the broadcast.

In another particular illustrative embodiment, the selected participant 106 is an entrepreneur attempting to garner viewers to invest in a product or service. For example, the participant may describe a product that is in the early stages of development and requires additional funds to complete the development and to bring the product to market. Accordingly, instead of the donations 126 being displayed and tallied, the results of the amount of money that viewers are willing to invest in the product are displayed.

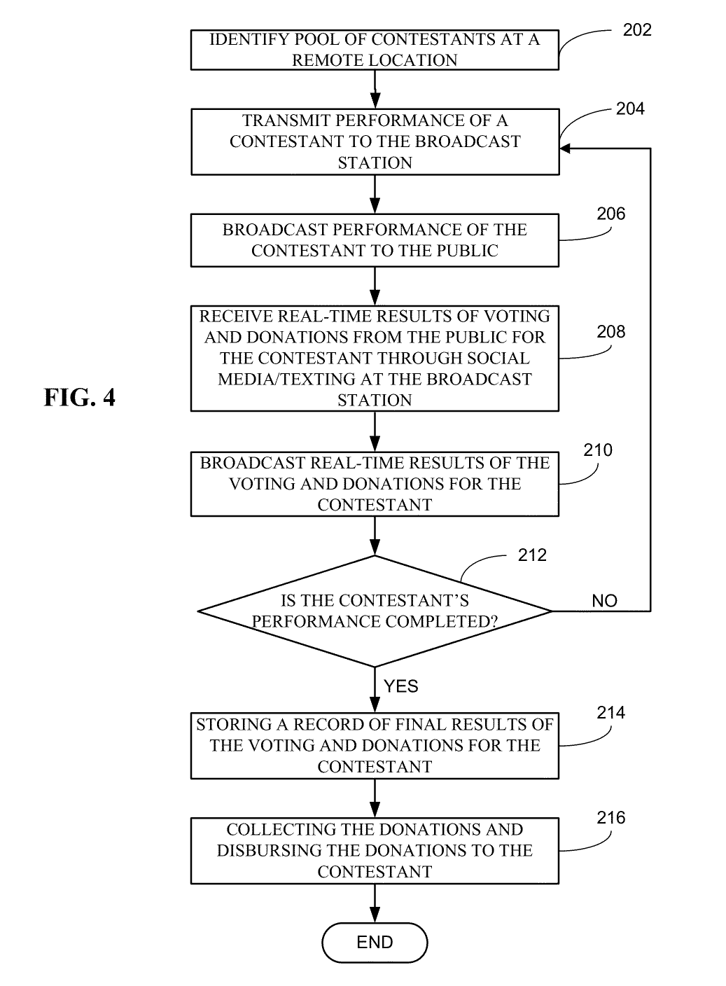

A flow diagram of a particular embodiment of a method of an interactive television program is described in FIG. 4 for a contestant attempting to raise donations. At 202, a pool of contestants at a remote location are identified. Moving to 204, the performance of the contestant is broadcast from the mobile television studio to the broadcast station. The performance of the contestant is broadcast to the public from the broadcast station, at 206. The real-time results of voting and donations from the public from the contestant is received, at 208, through social media, mobile devices, the Internet, or any combination thereof. The real-time results of the voting and donations for the contestant are broadcast, at 210. At 212, the performance and results continue to be broadcast in real-time until the performance is completed. A record of the final results of the voting and donations for the contestant is stored, at 214. The donations are collected, at 216, and disbursed to the contestant.

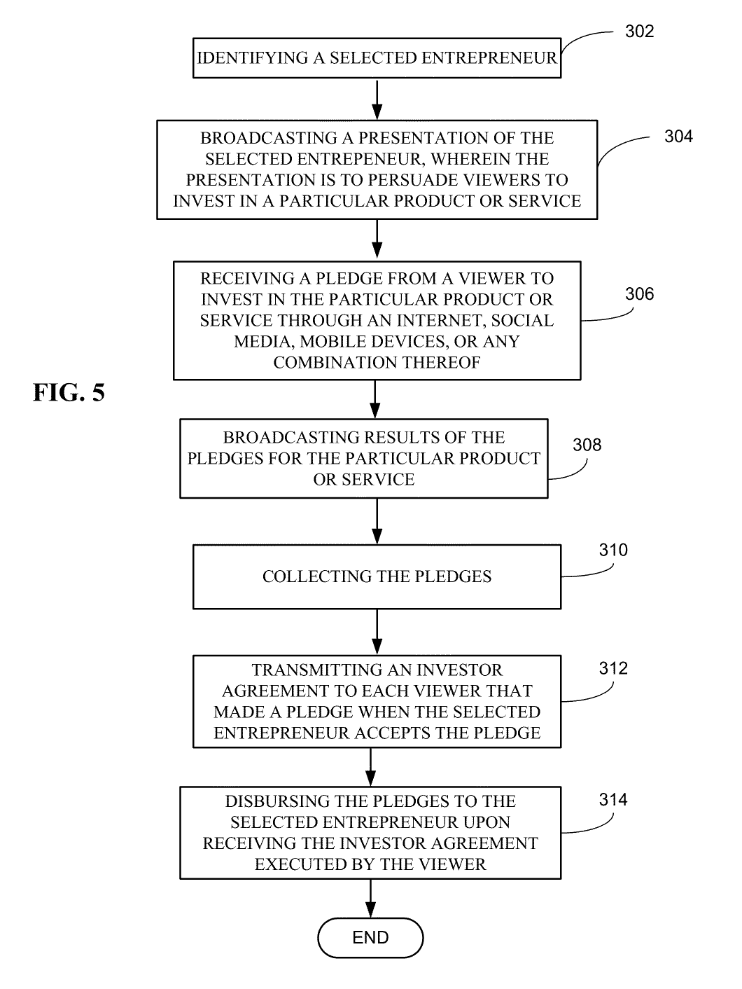

Referring now to FIG. 5, a flow diagram of a particular embodiment of a method of an interactive television program for an entrepreneur raising funds is described. As described above, an entrepreneur is selected, at 302, from a pool of contestants. Moving to 304, the presentation of the entrepreneur is broadcast from the mobile television studio to the broadcast station to persuade viewers to invest in a particular product or service. Pledges are received, at 306, from viewers to invest in the particular product or service through the Internet, social media, mobile devices, or any combination thereof. The real-time results of pledges from the viewers is broadcast, at 308, and, at 310, the pledges are collected. An investor agreement is transmitted, at 312, to each viewer that made a pledge when the entrepreneur accepts the pledge. The pledges are disbursed to the entrepreneur upon receiving the investor agreement executed by the viewer, at 314.

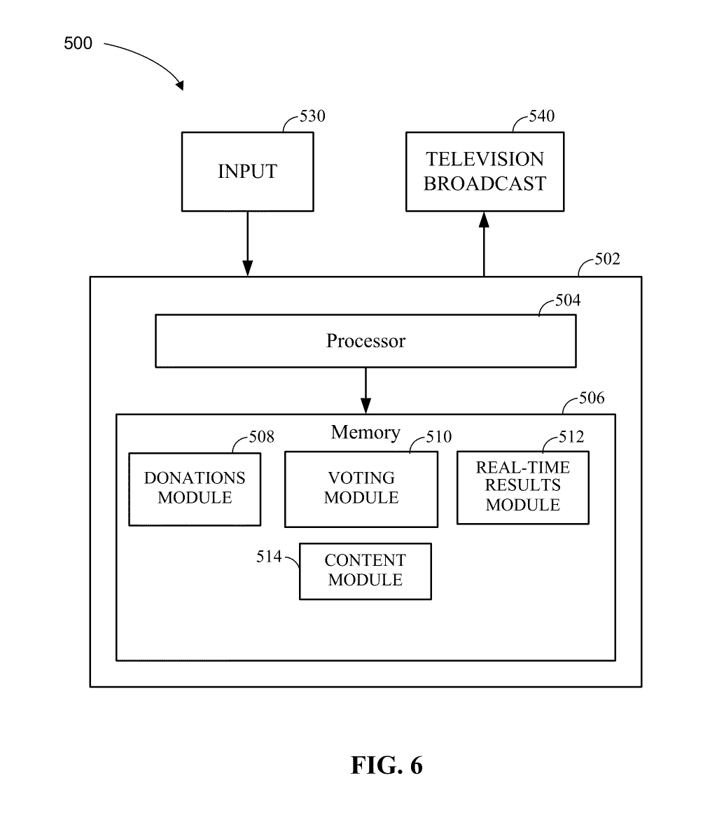

Referring to FIG. 6, a particular illustrative embodiment of a system for broadcasting the interactive television program is depicted and generally designated 500. The system 500 includes a processor 504 that is in communication with an input device 530, where a memory 506 of a server 502 may be adapted to store the results received for a particular participant. A donations module 508 may be used to record and store the donation information received for a particular contestant through social media, mobile, devices, or the Internet, for example, and to provide the donation information to the television broadcast in real-time. A voting module 510 may be used to receive and record voting results for a particular contestant and to provide the voting results in real-time to the television broadcast. A real-time results module 512 may be used to analyze the donations and voting information and format the information appropriately for display on a television as real-time results. This may include bar charts of the voting and donation results, indicate donation goals, or a simple number tally, for example. A content module 514 may be used to embed the real-time results into the performance of the contestant being currently broadcast in real-time. In addition, a transmitter or other output device 540 may be in direct communication with the server 502, where the output device transmits the real-time performance and results to the public for viewing on a television or mobile device, for example.

In another particular illustrative embodiment, the system includes a processor that is in communication with an input device, where a memory of a server may be adapted to store the pledges received for a particular entrepreneur. A pledges module may be used to record and store the pledges received for a particular entrepreneur through social media, mobile, devices, or the Internet, for example, and to provide the pledge information to the television broadcast in real-time. A real-time results module may be used to analyze the donations and format the information appropriately for display on a television as real-time results. This may include bar charts of the pledge results, indicate investment goals, or a simple number tally, for example. A content module may be used to embed the real-time results into the presentation of the entrepreneur being currently broadcast in real-time. In addition, a transmitter or other output device may be in direct communication with the server, where the output device transmits the real-time presentation and results to the public for viewing on a television or mobile device, for example. The modules may be implemented in hardware, firmware, software, other programmable logic, or any combination thereof. The memory includes media that is readable by the processor and that stores data and program instructions of the software modules that are executable by the processor.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method for an interactive television program, the method comprising:
identifying a pool of contestants;
transmitting a performance of a selected contestant to a television broadcast station;
broadcasting the performance of the selected contestant to viewers for the viewers to selectively pledge an amount of money for the selected contestant;
receiving results of pledges made for the selected contestant through an Internet, social media, mobile devices, or any combination thereof;
broadcasting the results of the pledges for the selected contestant;
collecting the money for the pledges; and
disbursing the money to the selected contestant.

2. The method of claim 1, wherein the pool of contestants are at a remote location from the television broadcast station.

3. The method of claim 1, wherein the results of the pledges are received at the television broadcast station.

4. The method of claim 1, wherein the money for the pledges is collected through the Internet, social media, mobile devices, or any combination thereof.

5. The method of claim 1, further comprising storing a record of final results of the pledges when the selected contestant's performance is completed.

6. The method of claim 1, further comprising displaying an amount of the pledges to the viewers as the performance is being broadcasted.

7. The method of claim 1, wherein the pledge is submitted by the viewer through a web page displayed on a viewer device.

8. A method for an interactive television program, the method comprising:
broadcasting a presentation of a selected entrepreneur, wherein the presentation is to persuade viewers to invest in a particular product or service;
receiving a pledge from a viewer to invest in the particular product or service through an Internet, social media, mobile devices, or any combination thereof;
broadcasting results of the pledges for the particular product or service;
collecting the pledges;
transmitting an investor agreement to each viewer that made a pledge when the selected entrepreneur accepts the pledge; and
disbursing the pledges to the selected entrepreneur upon receiving the investor agreement executed by the viewer.

9. The method of claim 8, wherein the pledge is received through the Internet, social media, mobile devices, or any combination thereof.

10. The method of claim 8, wherein the investor agreement is transmitted through the Internet, social media, mobile devices, or any combination thereof.

11. The method of claim 8, wherein the pledge is transmitted by the viewer through a web page displayed on a viewer device.

12. The method of claim 8, wherein the presentation of the selected entrepreneur is broadcast from a television station.

13. The method of claim 8, wherein the presentation of the selected entrepreneur is broadcast over the Internet, social media, mobile devices, or any combination thereof.

14. The method of claim 8, wherein the entrepreneur is at a remote location from the television broadcast station.

15. A method for an interactive television program, the method comprising:
viewing a presentation of a selected entrepreneur on a viewer device, wherein the presentation is to persuade viewers to invest in a particular product or service;
transmitting a pledge from the viewer device to a server operable to interact with the viewer device;
viewing results of the pledges for the particular product or service on the viewer device;
receiving an investor agreement when the selected entrepreneur accepts the pledge; and
funding the pledge to the selected entrepreneur upon executing the investor agreement.

16. The method of claim 15, wherein the pledge is transmitted through the Internet, social media, mobile devices, or any combination thereof.

17. The method of claim 15, wherein the investor agreement is transmitted through the Internet, social media, mobile devices, or any combination thereof, to the viewer.

18. The method of claim 15, wherein the pledge is transmitted by the viewer through a web page displayed on a viewer device.

19. The method of claim 15, wherein the presentation of the selected entrepreneur is broadcast from a television station.

20. The method of claim 15, wherein the presentation of the selected entrepreneur is broadcast over the Internet, social media, mobile devices, or any combination thereof.
